(19) United States
(12) Patent Application Publication
(10) Pub. No.: US 2017/0024497 A1
(43) Pub. Date: Jan. 26, 2017

(54) PRODUCT DESIGN CONSIDERING COST AND STRUCTURAL PERFORMANCE

(71) Applicant: Caterpillar Inc., Peoria, IL (US)

(72) Inventors: Naesung LYU, Champaign, IL (US); Vijay Krishna YALAMANCHILI, Champaign, IL (US); Wentao FU, Urbana, IL (US)

(73) Assignee: Caterpillar Inc., Peoria, IL (US)

(21) Appl. No.: 14/807,153

(22) Filed: Jul. 23, 2015

(51) Int. Cl. G06F 17/50; G06Q 10/06

(52) U.S. Cl. CPC G06F 17/5009; G06Q 10/067

(57) ABSTRACT

A method for implementing a computer-based product design system includes selecting a baseline set of design parameters for a product derived from a plurality of potential design concepts, and simulating a design model based on a parametrization of the design model using at least some of the selected design parameters. The method may include iteratively defining a plurality of variations of the simulated design model by simultaneously performing a structural analysis of each successive variation of the simulated design model, performing a cost analysis of each successive variation of the simulated design model, and combining the results of the analyses to arrive at a new variation of the simulated design model characterized by changes to both structural and cost parameters with respect to a previous variation of the simulated design model, wherein the changes move both the structural and cost parameters closer to target goals than in the previous variation, and obtaining a Pareto distribution of the plurality of variations of the simulated design model to arrive at a desired design concept for the product.

### TECHNICAL FIELD

This disclosure relates generally to computer-based product design and, more particularly, to computer-based product design considering cost and structural performance.

### BACKGROUND

Computer-based design methodologies may be used in many industries to facilitate engineering design applications. These design methodologies often use various processes or design models to model complex systems under design, such as internal combustion engines, communication networks, buildings, airplanes, power plants, etc. For example, an engine design may include computer models for engine combustion chambers, engine combustion and emission, fuel injection and mixing, intake and exhaust ports, and/or engine cooling systems. Computationally intense simulations are required to evaluate these design models.

The various process or design models may be simulated by using a large number of data sets of operating parameters and design parameters to derive corresponding output parameters. Optimization methods may be used to find optimum or desired design parameters corresponding to desired output parameters. The optimization of design models may be carried out by various techniques and may often involve many iterations of simulation. For example, U.S. Pat. No. 8,321,183 issued to Shah et al. on Nov. 27, 2012 (the '183 patent), discloses a computer-implemented method of designing a system to achieve a target goal. The method disclosed in the '183 patent creates an inventory of a plurality of variables that affect the design of the system. The inventory includes a feasibility range for each of the plurality of variables contained in the inventory. Initial values are assigned for the plurality of variables and a model of input to output correlations of the variables is created. The processor then attempts to achieve a goal for the system by manipulating the variables in a particular order based on the respective levels of effects.

While the method disclosed in the '183 patent may assist a product designer in determining modifications that should be made to various input variables to achieve system goals, there is still room for improvement. For example, the techniques disclosed in the '183 patent may be limited as a result of requiring manipulation of a plurality of design variables in a particular order. As one example, if variables that directly affect manufacturing costs are not manipulated until after having manipulated other variables that affect the structural strength of a part, it may be too late, too time consuming, and/or too expensive to make changes that would have resulted in significantly lower manufacturing costs for a part with acceptable strength characteristics.

Methods and systems consistent with certain features of the disclosed systems are directed to solving one or more of the problems set forth above or other problems in the prior art.

### SUMMARY

One aspect of the present disclosure includes a method for implementing a computer-based product design system. The method may include selecting a baseline set of design parameters for a product derived from a plurality of potential design concepts, and simulating, using a processor, a design model based on a parametrization of the design model using at least some of the selected design parameters. The method may further include iteratively defining, by the processor, a plurality of variations of the simulated design model by simultaneously performing a structural analysis and a cost analysis of each successive variation of the simulated design model, and combining, by the processor, the results of performing the structural analysis and the cost analysis to arrive at a new variation of the simulated design model characterized by changes to both structural and cost parameters with respect to a previous variation of the simulated design model, wherein the changes move both the structural and cost parameters closer to target goals than in the previous variation. The method may still further include obtaining, by the processor, a Pareto distribution of the plurality of variations of the simulated design model to arrive at a desired design concept for the product.

Another aspect of the present disclosure includes a computer-based product design system. The computer-based product design system may include a module configured for selecting a baseline set of design parameters for a product derived from a plurality of potential design concepts. The system may further include a module configured for simulating a design model based on a parametrization of the design model using at least some of the selected design parameters. The system may still further include a computer-implemented framework configured for iteratively defining a plurality of variations of the simulated design model by simultaneously performing a structural analysis and a cost analysis of each successive variation of the simulated design model, and combining the results of performing the structural analysis and the cost analysis to arrive at a new variation of the simulated design model characterized by changes to both structural and cost parameters with respect to a previous variation of the simulated design model, wherein the changes move both the structural and cost parameters closer to target goals than in the previous variation. The computer-implemented framework may be further configured to obtain a Pareto distribution of the plurality of variations of the simulated design model to arrive at a desired design concept for the product.

Another aspect of the present disclosure includes a computer-readable medium for use on a computer system configured to perform product design. The computer-readable medium may include computer-executable instructions for performing a method. The method may include selecting a baseline set of design parameters for a product derived from a plurality of potential design concepts, and simulating a design model based on a parametrization of the design model using at least some of the selected design parameters. The method may further include iteratively defining a plurality of variations of the simulated design model by simultaneously performing a structural analysis and a cost analysis of each successive variation of the simulated design model, and combining the results of performing the structural analysis and the cost analysis to arrive at a new variation of the simulated design model characterized by changes to both structural and cost parameters with respect to a previous variation of the simulated design model, wherein the changes move both the structural and cost parameters closer to target goals than in the previous variation. The method may still further include obtaining a Pareto distribution of the plurality of variations of the simulated design model to arrive at a desired design concept for the product.

### BRIEF DESCRIPTION OF THE DRAWINGS

FIG. 1 illustrates a block diagram of an exemplary computer-implemented product design system consistent with certain disclosed embodiments;

FIG. 2 illustrates a detailed block diagram of the exemplary computer-implemented product design system shown in FIG. 1.

### DETAILED DESCRIPTION

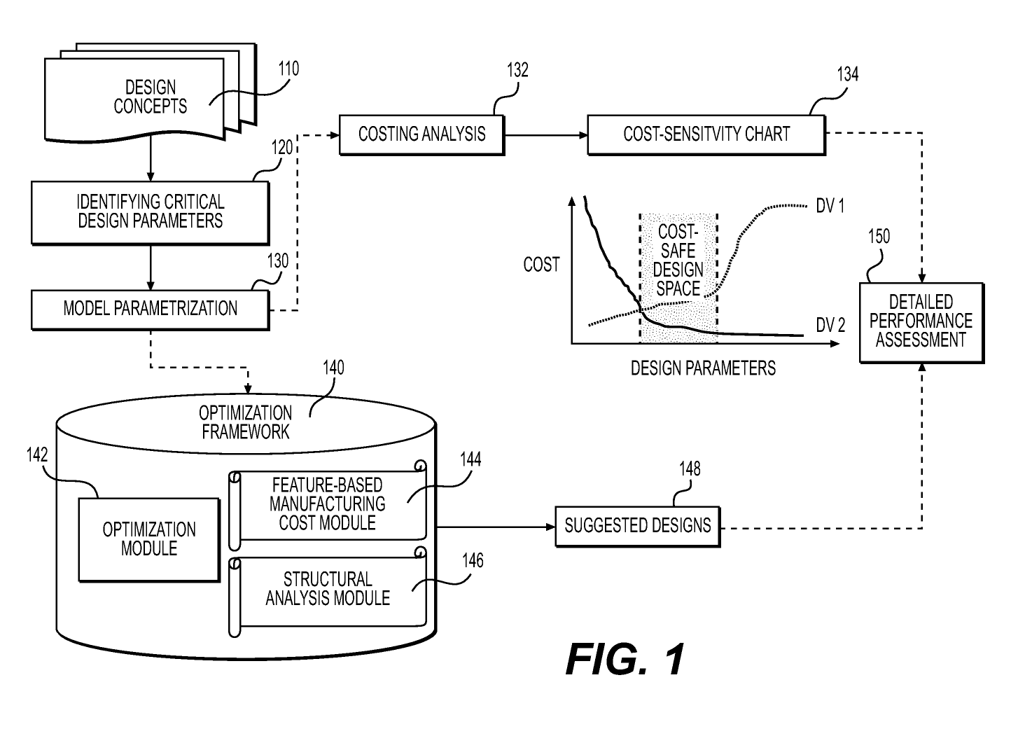

FIG. 1 illustrates a flowchart diagram of an exemplary computer-implemented product design system. As shown in FIG. 1, the system may include an input module 110 configured for initiating a design process using one or more baseline design concepts. The baseline design concepts may be based on engineering knowledge of the basic structural, functional, aesthetic, and/or utilitarian features of the product that is to be designed. In one exemplary implementation, the one or more design concepts may be selected from a plurality of alternative, feature-based, should-cost models developed using Computer Aided Design (CAD) application software alone or in conjunction with manufacturing cost management application software. PTC Creo™ Parametric is an example of CAD application software that may be used in designing alternative baseline 3D solid model geometries for the product. aPriori™ is an example of manufacturing cost management application software that may be used to evaluate cost-related parameters.

Each of the design features that has an effect on the manufacturing cost and/or structural characteristics for a particular design concept may have a range of values that define a design space. Any of the design alternatives may be selected from this design space. As shown in FIG. 1, the system may include a module 120 configured for identifying critical design parameters, and a module 130 configured for parametrization of the one or more design concepts that are initially selected as a starting point during the part design. In various exemplary implementations, the model parametrization may be performed by CAD application software such as PTC Creo™ Parametric, developed by PTC®. As further shown in FIG. 1, one or more design alternatives may be input into an integrated, computer-implemented framework 140. The computer-implemented framework 140 may include, for example, CAD structural analysis application software 146 and manufacturing cost management application software 144. The CAD structural analysis application software 146 may be configured for performing finite element (FE) structural analysis of a particular design concept for a selected product configuration. An example of structural analysis application software that may be implemented by the framework 140 is Creo™ Simulate. The framework 140 may be configured to implement the CAD structural analysis application software 146 in parallel with the manufacturing cost management application software 144. The manufacturing cost management application software 144 may be configured for performing an assessment of the total manufacturing costs associated with a particular parametrized model. The CAD application software 146 and the manufacturing cost management application software 144 may be configured to interface and communicate with an optimization module 142 within the framework 140. The optimization module 142 may be configured to simultaneously process sets of solutions for improving structural characteristics of the part and reducing manufacturing costs for producing the part. The optimization module 142 may employ one or more Multi-Objective Evolutionary Algorithms (MOEA), such as a Nondominated Sorting Genetic Algorithm (NSGA) to iteratively define a plurality of variations of a simulated design model.

The MOEA included in the computer-implemented framework 140 may be configured to identify a simulated, 3D design model having a set of desired characteristics that meet specific system goals. Examples of the desired characteristics for a simulated design model may include strength that has been improved over existing designs by a certain percentage or amount and manufacturing cost that has been reduced from costs associated with existing designs by a certain percentage or amount. Although improved strength and reduced cost are discussed as two potentially conflicting objectives for the framework 140, the MOEA may communicate with different and/or additional application software contained within the framework 140. The MOEA may be configured to obtain other design solutions with desired characteristics in addition or alternatively to improved strength and reduced cost. The design solutions may reflect tradeoffs among multiple objectives.

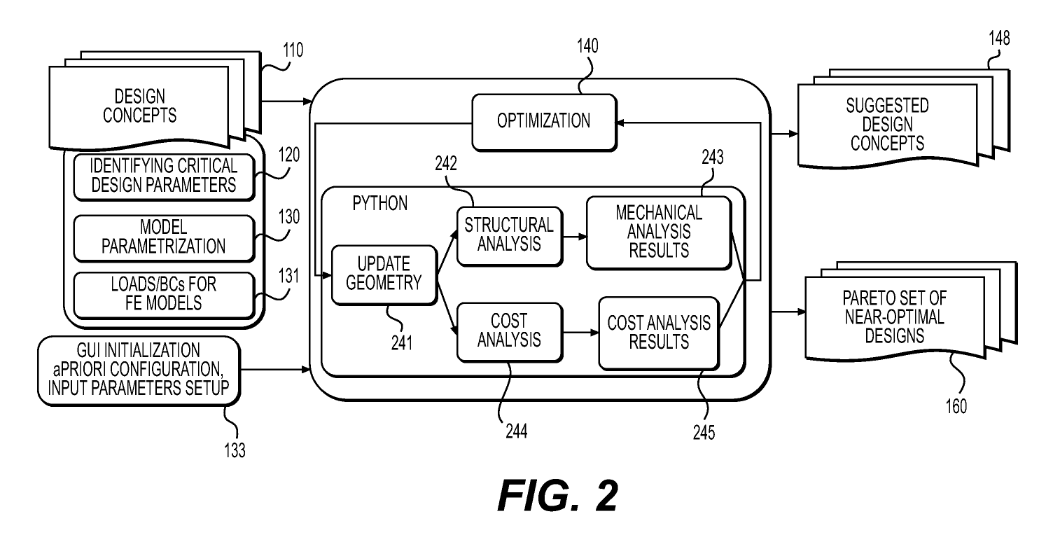

The framework 140 illustrated in FIGS. 1 and 2 may be configured to simultaneously perform a structural analysis and a cost analysis of each successive variation of the simulated design model. The framework 140 may be further configured to perform the structural analysis and cost analysis in parallel to arrive at a new variation of the simulated design model characterized by desired improvements to both structural and cost parameters with respect to a previous variation of the simulated design model. In various implementations of the disclosed system, the framework 140 may be configured to continue to perform multi-objective analyses in an iterative loop until target goals for multiple objectives or time limitations are reached. An output of the framework 140 may be a Pareto set of optimal or near-optimal design solutions that have both improved strength and reduced cost over one or more initial design concepts.

Multi-objective optimization (also referred to as Pareto optimization) is an area of multiple criteria decision making that is concerned with mathematical optimization problems involving more than one objective function to be optimized simultaneously. The MOEA implemented by the framework 140 enables identification of optimal decisions that are taken in the presence of trade-offs between two or more conflicting objectives. A Pareto set is a subset of the set of feasible points of solutions that contains all points that have at least one objective optimized while holding all other objectives constant. These points are called Pareto optimal points. In an exemplary implementation where a goal of the system is to produce a bracket having the greatest possible strength and the lowest possible cost, a processor running the MOEA within the framework 140 may determine that increasing the length of the bracket beyond a certain threshold results in a further improvement in the strength, but at an increase in the cost for manufacturing the bracket. A Pareto point determined by the processor in this implementation is one where no feasible points exist that yield a lower cost or higher strength while keeping the other objective fixed. The Pareto set of optimal or near-optimal designs would contain all potentially optimal solutions or designs given all possible trade-off situations. In various alternative implementations, examples of potentially conflicting objectives for the framework 140 may include improved structural strength of a product, reduced manufacturing costs associated with producing the product, improved fluid flow characteristics for the product, improved aerodynamic characteristics of the product, reduced weight, reduced amount of materials used in producing the product, reduced manufacturing time, improved environmental considerations (such as a reduced carbon footprint associated with production of a particular design concept), reduced fuel consumption potentially associated with a designed product, reduced emission of pollutants potentially associated with the designed part, and improved manufacturability of the product.

One or more of the optimal design concepts may be provided as feedback to the input module 110 and used by the input module 110 as a feature-based, should-cost design concept during initiation of a subsequent design process. Examples of design parameters that may be provided as inputs to a processor during a design process for a particular fabricated product may include one or more of a thickness of a plate or shell, a thickness of a coating, placement and size of holes, slots, or recesses, dimensions of a bend radius, dimensions of brackets or other attachment features, dimensions of bosses, dimensions of machined fillets, dimensions of welds or other joining features, and dimensions and locations of machined, molded, cast, or formed surface contours and other internal and external features of the product. A baseline 3D solid model geometry for the product being designed may be defined using the CAD application software and taking into consideration one or more of the design parameters.

The manufacturing cost management application software, such as aPriori™, may address common manufacturing processes including sheet metal fabrication, bar and tube fabrication, welded or mechanical assemblies, plastic molding, sand and die casting, forging, turning and multi-axis machining and a variety of heat treatments and surface treatments or finishing operations. The manufacturing cost management application software may be configured to assess the total cost for producing a product with a particular 3D geometry based on many factors that may include the materials being used, the quantity of the product that will be manufactured, the types of processes that will be used during manufacture and assembly of the product, and the geographical location where manufacturing and assembly will be performed. An exemplary CAD application software that may be configured to extract structural information for the various conceptual 3D design models of the part is the Creo™ Simulate application.

The module 120 of the system shown in FIG. 1 may be configured for identification of the most critical design parameters for a particular product. Identification of the most critical design parameters for a product may be based on historical data and/or empirical data. The historical data may be accumulated over time, for example, by extracting the sensitivity of cost and structural characteristics for a particular design concept relative to each of the design parameters that are input into the CAD application software and the manufacturing cost management application software included within the framework 140. As shown in FIG. 1, a costing analysis module 132 may be configured to correlate different critical design parameters with associated costs in developing a cost-sensitivity chart 134, or other mapping demonstrating the relationship between the various critical design parameters and the resulting manufacturing costs. For example, the costing analysis module 132 may determine that changes in the dimensions of a bolt hole located on a part may have very little effect on manufacturing costs for the part, while changes in the thickness of a portion of the part, or changes to a surface contour of the part may have a much more significant impact on overall manufacturing costs for the part. In alternative implementations, a structural analysis module may also be included along with the costing analysis module 132 in order to also extract the sensitivity of structural characteristics relative to the various design parameters. In some instances, certain design parameters may have more of an impact on structural characteristics and less of an impact on cost, or more impact on cost and less on structural characteristics. Other design parameters, such as the geographical locations where a product will be manufactured, may not have any impact on structural characteristics for the product, but a significant impact on cost. Identification of the critical design parameters from the perspective of any one or more of the potentially conflicting system goals may help to improve the efficiency and effectiveness of the entire system. Structural analysis, cost analysis, and optimization of the results from both analyses as performed by the MOEA may focus the analytical resources of the framework 140 on the design variables that will make the most difference in arriving at one or more Pareto sets of near-optimal designs.

Output from the module 120 after identification of the critical design parameters may be provided to the module 130. The module 130 may be configured for parametrization of each feature-based, should cost model derived using one or more CAD models and the critical design parameters. Parametrization of the selected design concepts identifies parametric equations that define the surfaces, geometry, and other feature characteristics for the various design concepts. Parametrization of the part surfaces, plate thicknesses, bolt hole diameters, bracket dimensions, and other internal and external design features identifies sets of coordinates that allow unique identification of any point on the part surfaces or other part features as a function of a particular parameter. The parametric equations identified by module 130 may be provided to the framework 140 and used in the cost analysis, structural analysis, and optimization for the development of suggested designs 148. Output from both the determination of what design parameters have the greatest effect on cost, as performed by the costing analysis module 132, and from the suggested designs that result from the parallel cost analysis and structural analysis performed by the framework 140 may then be fed to a detailed performance assessment module 150. Feedback from the performance assessment module 150 may be used in further identification of critical design parameters, and may also contribute to the identification of new baseline 3D solid model design concepts used when initiating a new design process.

As shown in FIG. 2, the system may also include a graphical user interface (GUI) 133 as an exemplary input/output (I/O) interface, which may provide for configuration of the aPriori™ and Creo™ application software, input of various design parameters, and other setup functions. Input parameters entered by a user at the GUI 133 may include any appropriate type of data associated with a particular design application. In addition, a module 131 may be configured to receive load data and other information relevant for performing FE structural analysis of the various product design concepts. For example, in a bracket design application, the input parameters may include various constraints imposed by the overall space available for the bracket in its final application, the location and size of mounting holes as required by the parts the bracket will be joining, the loads that will be imposed upon the bracket, the environment the bracket will be exposed to, and any material constraints and/or manufacturing constraints that will be present during the production of the bracket. The output solutions of the system may also be displayed on the GUI 133, and may include one or more Pareto sets of optimal or near-optimal designs resulting from the series of iterations performed by the MOEA in the framework 140.

As shown in FIG. 2, the framework 140 may be configured to include an update geometry module 241, which receives the results of each successive iteration of the MOEA applied to the structural analysis results and manufacturing cost results. A structural analysis module 242 may be configured to perform FE stress analysis and other analysis of structural characteristics of each design concept using structural analysis application software such as Creo™ Simulate. A cost analysis module 244 may be configured to perform manufacturing cost analysis in parallel with the structural analysis using manufacturing cost management application software such as aPriori™. The structural analysis module 242 may be configured to populate a report or provide iterative mechanical analysis results to the optimization framework 140 through a module 243 configured to output the mechanical analysis results. The cost analysis module 244 may be configured to populate an Excel spreadsheet or otherwise provide iterative cost results to the optimization framework 140 through a module 245 configured to output the cost analysis results in a desired format.

The structural analysis module 242 and the cost analysis module 244 may be configured to interface and communicate with the MOEA in the framework 140. The MOEA may iteratively define a plurality of variations of a simulated and parametrized design model by simultaneously evaluating the results of the structural analysis of each successive variation of the simulated design model and the results of the manufacturing cost analysis of each successive variation of the simulated design model. The MOEA may combine the results of performing the structural and cost analyses in parallel to arrive at successive new variations of the simulated design model characterized by desired improvements to both structural and cost parameters with respect to a previous variation of the simulated design model. After performance of a number of iterative loops of the various, multi-objective analyses performed within the framework 140, the MOEA may obtain one or more Pareto sets of optimal or near-optimal designs 160 and arrive at one or more suggested design concepts 148

The optimization process performed by the MOEA in the framework 140 may be implemented as a searching process to search the valid input space of input design parameters to find a desired set of values of input design parameters that result in desired values of output parameters. Input space may refer to entire ranges of valid values of input parameters. In certain embodiments, genetic algorithms (GA) may be used by the MOEA to carry out the optimization process or the searching process. Other algorithms, such as fuzzy logic algorithms, may also be used. The MOEA may include more than one GA. In one exemplary implementation a first genetic algorithm may be used to find optimized design parameters based on one or more simulations of the geometry characterizing a 3D solid model design. A second genetic algorithm may be used in parallel with the first genetic algorithm to find optimized design parameters based on one or more simulations of a series of manufacturing processes that may be used to produce a part having the simulated 3D geometry. The first and second genetic algorithms may use the same or different search spaces and/or the same or different searching ranges during the optimization process performed within the framework 140. A search space may refer to a certain range of valid values of input design parameters. A search space may cover the entire range of values of input design parameters (i.e., input space) or a subset range of values of the input design parameters. A subset range of values of the input design parameters may be derived for only the critical design parameters identified or received by the module 120.

The structural analysis, cost analysis, and optimization performed by the MOEA within the framework 140 may be implemented by one or more computer-implemented systems. A computer-implemented system may include one or more processors or controllers, a random access memory (RAM), a read-only memory (ROM), a console, an input/output device, a network interface, a database, and a storage. It is understood that the type and number of listed devices are exemplary only and not intended to be limiting. The number of listed devices may be changed and other devices may be added. The one or more processors employed by the system to implement the disclosed design processes may include any appropriate type of general purpose microprocessor, digital signal processor, or microcontroller. Each processor may execute sequences of computer program instructions to perform various processes as explained above. Each processor may be coupled to or access other devices, such as the RAM, ROM, computer-readable medium, console, input/output device, network interface, database, and/or storage, to complete executions of computer program instructions. The computer program instructions may be loaded into the RAM for execution by the processor from read-only memory (ROM), or from storage. Storage may include any appropriate type of mass storage provided to store any type of information that the processor may need to perform the processes. For example, the storage may include one or more hard disk devices, optical disk devices, or other storage devices to provide storage space.

As shown in FIG. 2, the system may include a GUI 133 to display information to users of the computer-implemented system, and to accept inputs from the users. The GUI may be displayed on any appropriate type of computer display device or computer monitor. Various other input devices may be provided for users to input information into the computer-implemented system. Exemplary input devices may include a keyboard, a mouse, or other optical or wireless computer input device, etc. Further, a network interface may provide communication connections such that the computer-implemented system may be accessed remotely through computer networks via various communication protocols, such as transmission control protocol/internet protocol (TCP/IP), hyper-text transfer protocol (HTTP), etc.

As discussed above, the processes performed within the framework 140 include operation of the MOEA, which interfaces with and communicates with the structural analysis module 242 and the cost analysis module 244. The MOEA may include any appropriate type of genetic algorithm that may be used to find possible optimized solutions based on the principles of adopting evolutionary biology to computer science. When applying a genetic algorithm to search a desired subset of potential design variables and/or a desired set of values of the variables, the variables may be represented by a list of parameters used to drive an evaluation procedure of the genetic algorithm. The parameter list may be called a chromosome or a genome, which may represent an encoding of all variables, either selected or unselected. For example, a “0” encoding of a variable may indicate that the variable is not selected, while a “1” encoding of a variable may indicate that the variable is selected. Chromosomes may also include genes, each of which may be an encoding of a value of an individual variable. In the bracket design example discussed above, a chromosome may represent a collection of design parameters such as plate thickness, bolt hole diameter, and bracket length, and the genes may represent various possible values for each design parameter. Chromosomes and/or genes may be implemented as strings of data and/or instructions. In various exemplary implementations the variables input during the design of a product using the disclosed system may include one or more of the dimensions of various features of the product, the materials used in the product, the types of manufacturing processes used to make the product, the loads that will be imposed on the product, the structural strength characteristics of the materials used in the product, any coatings, heat treatments, or post-machining processes that may be used, the particular facilities or geographical locations where the product is made, the quantity of the product that will be made, any time constraints involved, etc.

Initially, several such parameter lists or chromosomes and corresponding genes may be generated to create a generation. A generation may be a collection of a certain number of chromosomes and/or genes. The chromosomes and/or genes in the generation may be evaluated based on a fitness function, and a value of fitness may be returned by the fitness function. The generation may then be sorted, with those having better fitness ranked at the top as the fittest chromosomes and/or genes. Fitness may be evaluated based on the particular design application. In the bracket design example discussed above, fitness may be evaluated based on whether a strength of a particular simulated 3D design model for the bracket is above a predetermined level and whether a manufacturing cost for the bracket is below a predetermined threshold, based on simulation results of the model.

A second generation may be generated from the sorted initial generation by using any or all of the genetic operators, such as selection, crossover (or reproduction), and mutation. During selection, chromosomes and/or genes in the generation with fitness values below a predetermined threshold may be deleted. Selection methods, such as roulette wheel selection and/or tournament selection, may also be used.

After selection, reproduction operation may be performed upon the selected chromosomes and/or genes. Two selected chromosomes and/or genes may be crossed over along a randomly selected crossover point. Two new child chromosomes and/or genes may then be created and added to the generation. The reproduction operation may be continued until the generation size is restored. In the bracket design exemplary implementation, one selected chromosome may be associated with a combination of all design parameters including plate thickness, bolt hole diameter and bracket length that gives a better mechanical performance, and another selected chromosome may be associated with a different combination of these design parameters that results in lower manufacturing costs associated with the types of machining operations used to produce the part.

Further, once the generation size is restored, mutation may be selectively performed on the generation. Mutation may be performed on a randomly selected chromosome by, for example, randomly altering bits in the chromosome data structure.

Selection, reproduction, and mutation may result in a second generation having chromosomes and/or genes that are different from the initial generation. The average degree of fitness may be increased by this procedure for the second generation, since better fitted chromosomes and/or genes from the first generation may be selected. This entire process may be repeated for any appropriate numbers of generations until the genetic algorithm converges. Each repeat may be referred to as an iteration of generation of simulated design models.

Convergence may be determined if the result of the genetic algorithm is improved during each generation and the rate of improvement falls below a predetermined rate. Convergence may also be determined by the fitness function or if the value of a particular variable or variables reach a predetermined range. Other convergence determining methods, however, may also be used.

### INDUSTRIAL APPLICABILITY

The disclosed systems and methods may provide efficient and effective solutions to reduce the amount of time and/or computation associated with obtaining an optimum solution for a given search space of design parameters for a particular design concept. The framework 140 may process only the design parameters that have been previously determined to have the largest effect on multiple objectives. In an exemplary implementation discussed above, the framework 140 may process structural analysis of a selected and parametrized 3D solid design model simultaneously with manufacturing cost analysis to arrive at a Pareto set of optimal or near-optimal designs for a product. The MOEA employed within the framework 140 may use one or more genetic algorithms in order to quickly converge on design solutions for a product that address multiple objectives for the product.

The disclosed systems and methods may include selecting a baseline set of design parameters for a product derived from a plurality of potential design concepts. After having selected a particular baseline design concept, a 3D solid design model representing the selected design concept may be parametrized. The model parametrization may be based in particular on design parameters that have been previously identified as “critical” design parameters, which are the design parameters determined to have the largest effect on the particular objectives for the design system. In an implementation where manufacturing cost is an important objective for the system, the critical design parameters may be selected from a comparison of variations to values for a set of design parameters relative to resulting variations to manufacturing costs.

The computer-implemented framework 140 for the product design system may include structural analysis application software 146, manufacturing cost analysis application software 144, and the optimization module 142 implementing a MOEA. The framework 140 may iteratively define a plurality of variations of a simulated 3D design model by simultaneously performing a structural analysis and a cost analysis of each successive variation of the simulated design model. The framework may combine the results of performing the structural analysis and the cost analysis using the MOEA to arrive at a new variation of the simulated design model characterized by changes to both structural and cost parameters with respect to a previous variation of the simulated design model. The changes derived by the MOEA move both the structural and cost parameters closer to target goals and objectives for the design system than in the previous variation of the 3D design model. A Pareto distribution of the plurality of variations of the simulated 3D design model may be obtained by the framework to arrive at a desired design concept and simulated 3D design model for the product.

The disclosed systems and methods may also be integrated into other design environments, such as another CAD environment, so that users of the design environment may use the disclosed systems and methods transparently (i.e., without knowing that the underlying framework includes a MOEA that is combining the results of structural analysis and manufacturing cost analysis for a particular design concept). In different configurations, the disclosed systems and methods may also be used to provide the product design optimization application software to a plurality of design environments concurrently by, for example, using a centralized server connected to a computer network and incorporating the disclosed systems.

Other embodiments, features, aspects, and principles of the disclosed exemplary systems and methods will be apparent to those skilled in the art and may be implemented in various environments and systems.

What is claimed is:

1. A method for implementing a computer-based product design system, comprising:
selecting a baseline set of design parameters for a product derived from a plurality of potential design concepts;
simulating, by a processor, a design model based on a parametrization of the design model using at least some of the selected design parameters;
iteratively defining, by the processor, a plurality of variations of the simulated design model by simultaneously:
performing a structural analysis of each successive variation of the simulated design model;
performing a cost analysis of each successive variation of the simulated design model; and
combining, by the processor, the results of performing the structural analysis and the cost analysis to arrive at a new variation of the simulated design model characterized by changes to both structural and cost parameters with respect to a previous variation of the simulated design model, wherein the changes move both the structural and cost parameters closer to target goals than in the previous variation; and
obtaining, by the processor, a Pareto distribution of the plurality of variations of the simulated design model to arrive at a desired design concept for the product.

2. The method of claim 1, wherein selecting a baseline set of design parameters includes identifying which design parameters have the largest effect on at least one of structural characteristics and costs associated with a potential design concept.

3. The method of claim 2, wherein simulating a design model is based on a parametrization of the design model using the design parameters identified as having the largest effect on at least one of structural characteristics and costs.

4. The method of claim 3, wherein simulating a design model is based on a parametrization of the design model using the design parameters identified as having the largest effect on both the structural characteristics and the costs.

5. The method of claim 1, wherein the baseline set of design parameters for a product includes one or more of a thickness of a plate or shell, a thickness of a coating, placement and size of holes, slots, or recesses, dimensions of a bend radius, dimensions of brackets or other attachment features, dimensions of bosses, dimensions of machined fillets, dimensions of welds or other joining features, and dimensions and locations of machined, molded, cast, or formed surface contours.

6. The method of claim 1, wherein simulating a design model is performed with one or more CAD applications configured for generating a parametrized 3D design model of a product being designed by the computer-based product design system.

7. The method of claim 1, wherein combining the results of performing the structural analysis and the results of performing the cost analysis includes inputting the results from both the structural analysis and the cost analysis into a Multi-Objective Evolutionary Algorithm (MOEA).

8. The method of claim 1, wherein performing the structural analysis uses at least some of the same design parameters as performing the cost analysis.

9. The method of claim 8, wherein performing the cost analysis uses parameters additional to the design parameters used in performing the structural analysis.

10. A computer-based product design system, comprising:
a module configured for selecting a baseline set of design parameters for a product derived from a plurality of potential design concepts;
a module configured for simulating a design model based on a parametrization of the design model using at least some of the selected design parameters;
a computer-implemented framework configured for iteratively defining a plurality of variations of the simulated design model by simultaneously:
performing a structural analysis of each successive variation of the simulated design model;
performing a cost analysis of each successive variation of the simulated design model; and
combining the results of performing the structural analysis and the cost analysis to arrive at a new variation of the simulated design model characterized by changes to both structural and cost parameters with respect to a previous variation of the simulated design model, wherein the changes move both the structural and cost parameters closer to target goals than in the previous variation, and wherein the computer-implemented framework is further configured to obtain a Pareto distribution of the plurality of variations of the simulated design model to arrive at a desired design concept for the product.

11. The computer-based product design system of claim 10, wherein the module configured for selecting a baseline set of design parameters for the product is further configured to receive identification of which design parameters have the largest effect on at least one of structural characteristics and costs associated with a potential design concept.

12. The computer-based product design system of claim 11, wherein the module configured for simulating a design model is further configured to base the parametrization of the design model on the design parameters identified as having the largest effect on at least one of structural characteristics and costs.

13. The computer-based product design system of claim 12, wherein the module configured for simulating a design model is further configured to base the parametrization of the design model on the design parameters identified as having the largest effect on both the structural characteristics and the costs.

14. The computer-based product design system of claim 10, wherein the baseline set of design parameters for a product includes one or more of a thickness of a plate or shell, a thickness of a coating, placement and size of holes, slots, or recesses, dimensions of a bend radius, dimensions of brackets or other attachment features, dimensions of bosses, dimensions of machined fillets, dimensions of welds or other joining features, and dimensions and locations of machined, molded, cast, or formed surface contours.

15. The computer-based product design system of claim 10, wherein the module configured for simulating a design model includes one or more CAD applications configured for generating a parametrized 3D design model of a product being designed by the computer-based product design system.

16. The computer-based product design system of claim 10, wherein the computer-implemented framework is further configured to combine the results of performing the structural analysis and the results of performing the cost analysis by inputting the results from both the structural analysis and the cost analysis into a Multi-Objective Evolutionary Algorithm (MOEA).

17. The computer-based product design system of claim 16, wherein the computer-implemented framework is further configured to perform the structural analysis using at least some of the same design parameters as used when performing the cost analysis.

18. The computer-based product design system of claim 16, wherein the computer-implemented framework is further configured to perform the cost analysis using parameters additional to the design parameters used in performing the structural analysis.

19. A computer-readable medium for use on a computer system configured to perform product design, the computer-readable medium comprising computer-executable instructions for performing a method with at least one processor, wherein the method comprises:
selecting a baseline set of design parameters for a product derived from a plurality of potential design concepts;
simulating a design model based on a parametrization of the design model using at least some of the selected design parameters;
iteratively defining a plurality of variations of the simulated design model by simultaneously:
performing a structural analysis of each successive variation of the simulated design model;
performing a cost analysis of each successive variation of the simulated design model; and
combining the results of performing the structural analysis and the cost analysis to arrive at a new variation of the simulated design model characterized by changes to both structural and cost parameters with respect to a previous variation of the simulated design model, wherein the changes move both the structural and cost parameters closer to target goals than in the previous variation, and obtaining a Pareto distribution of the plurality of variations of the simulated design model to arrive at a desired design concept for the product.

20. The computer-readable medium of claim 19, wherein the method further includes selecting the baseline set of design parameters from design parameters have the largest effect on at least one of structural characteristics and costs associated with a potential design concept.
